(19) United States
(12) Patent Application Publication
(10) Pub. No.: US 2010/0277594 A1
(43) Pub. Date: Nov. 4, 2010

(54) Imaging System with Wavefront Modification

(75) Inventors: Thibault Augey, Paris (FR); Quentin Guillerm, Paris (FR); Michel Jegouzo, Paris (FR)

Correspondence Address: FROST BROWN TODD, LLC, 2200 PNC CENTER, 201 E. FIFTH STREET, CINCINNATI, OH, 45202, US

(73) Assignee: Sagem Defense Securite, Paris (FR)

(21) Appl. No.: 12/681,548

(22) PCT Filed: Oct. 10, 2008
(86) PCT No.: PCT/FR2008/051847

§ 371 Date: Apr. 2, 2010

(30) Foreign Application Priority Data
Oct. 12, 2007 (FR) 0707177

(51) Int. Cl. H04N 5/232; H04N 5/228; H04N 5/33

(52) U.S. Cl. 348/164; 348/222.1; 348/345; 348/E05.031; 348/E05.09; 348/E05.045

(57) ABSTRACT

An imaging system (10) comprises an objective (1), an image detector (2) placed in an image plane of the objective, and a calculation unit (3) intended for executing a digital processing of an image captured by the detector. The objective is suitable for modifying a wavefront of a radiation which enters the system, so that an illumination on the detector which is produced by a source of the radiation is constant for a large interval of variation of a distance of separation of the source from the objective. The depth of field of the system is thus increased, and the calculation unit can be simplified by using a constant filter. The modification of the wavefront is created by a profile which is invariant under any rotations about the optical axis of the objective.

The invention relates to an imaging system with wavefront modification, as well as a method for increasing the depth of field of an imaging system.

In general, an imaging system comprises an objective and an image detector which is placed in an image plane of the objective. The detector is usually a matrix of photosensitive elements, also called pixels. It is connected to an image processing and storage system. The objective forms the image of a scene which is present in a field of view of the system, and the detector captures this image. Such imaging systems are, for example, binoculars, video cameras, digital cameras or camera phones, which can be adapted to form images from visible or infrared radiation produced by the scene.

It is known that an object in the scene appears clear in the captured image if the rays which originate from a same point of this object and which pass through the objective converge at a point which is located in the plane of the detector. If the rays converge before or after the plane of the detector, the object appears blurred in the image. To a person skilled in the art, an incorrect convergence of this type is called defocusing.

Such defocusing may have several causes, including:
variations in the distance between an object in the scene and the objective, particularly when the scene comprises multiple objects located at varying distances, with differences which can reach 100 m (meters) for example for a focal distance greater than 300 m. In this case, the entire scene cannot be in focus for the objective. The size of the interval of variations in the object distance for which the image of the object remains clear is called the depth of field;
variations in the position and/or optical characteristics of certain components of the objective when an operating temperature of the imaging system varies, for example between −40° C. and 70° C.;
displacements in the point of convergence of the rays issuing from a same point in the scene, along the optical axis of the objective, as a function of the wavelength of the radiation when the image of the scene is formed from radiation of different wavelengths. This cause of defocusing is called axial chromatic aberration;
the scene image which is formed by the objective is curved, even if all the objects in the scene are located in a plane at the same distance from the objective. This cause of defocusing is known as field curvature.

Some of these causes of defocusing can be reduced by an appropriate design of the objective. This is the case for example for temperature-compensating objectives, in which the different contributions to thermal defocusing compensate for each other. There are also achromatic objectives which have reduced axial chromatic aberration. Such objectives are more complex and are quite costly, particularly when they are adapted to operate in the infrared frequency range.

In order to offer systems which are less sensitive to defocusing of any origin, it is possible to increase the depth of field, in particular by modifying a wavefront of the radiation entering the system in order to form the image that is captured. Such a technique is known as “Wavefront Coding™”. It consists in voluntarily introducing supplemental phase delays for the radiation that forms the image. These delays vary between different points in the same wavefront of the radiation, and increase the depth of field. They are commonly produced by means of a phase plate of variable thickness which is placed in a pupil of the objective. Alternatively, a surface of an optical component of the objective, such as a lens, mirror, or prism, can be modified to achieve the delay modifications in the wavefront.

But, the surfaces which have been used in the past to perform such wavefront modifications are complex surfaces which, in particular, are not rotationally invariant around the corresponding optical axis. They therefore require specific machine tools which are complex and costly. In addition, the machining of surfaces which are not rotationally invariant requires verifying a large number of geometric parameters, which must be done by a specially trained person.

One object of the invention therefore consists in proposing an imaging system with wavefront modification which is less costly and less complex than known systems.

More particularly, an object of the invention is an imaging system with wavefront modification in which the wavefront modification surface is rotationally invariant.

Another object of the invention consists in mitigating as much as possible the defocus of the system caused by at least one of the following: varying distances of objects in the scene, thermal variations, axial chromatic aberration, and field curvature.

To this end, the invention proposes an imaging system which comprises:
an objective which has an optical axis and a pupil,
an image detector which is placed in an image plane of the objective and which is adapted to capture an image of a scene formed by this objective, and
a processing unit which is intended to execute a digital processing of the image captured by the detector.

The objective is additionally adapted to modify a wavefront of the radiation which passes through it, so that a response function of the objective is substantially constant over a large interval of variations in the distance between the objects of the scene and the objective. In addition, the processing unit is adapted so that the processing of the image captured by the detector is based on data of the response function.

The system of the invention is characterized in that the wavefront modification corresponds to an effect of a diopter which is situated in at least part of the pupil of the objective. This diopter is rotationally invariant about the optical axis of the objective and has a longitudinal shift which corresponds to one of the following profiles S(u), with a maximum deviation of less than 1% in absolute value relative to this profile:

S(u)=A₀·u·(u−1)·(A·u²+B·u+C)+S₀(u) (1)

where u=r/R, r being the radial distance in the pupil and R the radius of this pupil.

$$A = \frac{2 - 3 β - {αβ ( β - 1 )}^{2}}{{{β}^{3} ( β - 1 )}^{2}} ;$$

$$B = \frac{4 β - 3 + 2 {αβ ( β - 1 )}^{2}}{{{β}^{2} ( β - 1 )}^{2}}$$

$$and$$

$$C = - α$$

and α, β, and A₀ are selection parameters for the profile, which are within the following intervals:

[1.0; 6.0] for α

[0.42; 0.74] for β; and

[1.5·λ/(n−1); 7.5λ/(n−1)] for A₀ using the absolute value,

λ being the wavelength of the radiation that forms the image and n being an optical refractive index of the diopter for this wavelength.

S₀(u) is a contribution to the diopter profile which corresponds to a constant curvature. In the context of the invention, constant curvature is understood to mean a curvature which has a uniform value across the diopter. This value may possibly be zero. Such a constant curvature can modify the position of the image plane of the objective.

Thus, the wavefront modification diopter proposed by the invention has one of the profiles S(u) and is rotationally invariant about the optical axis of the objective. In other words, this diopter has rotational symmetry, meaning that it is identical in appearance at any angle of rotation about the optical axis. This diopter can then be machined quite simply, in particular with the use of a two-axis machine tool. Such a machine drives in rotation about the axis of rotational symmetry, one of the optical components of the objective which is to be machined in accordance with the profile S(u). Such a machine tool is commonly available and simple to use while allowing very precise machining. As a result, an imaging system of the invention can be manufactured at a reduced cost. It can therefore be an imaging system intended for mass production, such as a system for personal use. For example, the imaging system can comprise a pair of infrared binoculars.

In particular, the wavefront modification may be at least partially provided by a surface of a lens, mirror or prism of the objective. It may also be performed by a phase plate which is added to the imaging system. In this case, the phase plate is advantageously situated in the pupil of the objective, so as to modify the wavefront in a manner that is substantially identical, in the first order, for all points in the field of view of the objective.

The profile S(u) may possibly be distributed over several optical components of the objective. It may also be distributed between a specific phase plate and one or more optical components of the objective.

Given that the response function of the objective is substantially constant over a large interval of distance variations between the objects of the scene and the objective, the depth of field of the imaging system is increased. In particular, the invention can increase the depth of field of the system by a factor of more than three, or even more than five.

For this reason, the invention is particularly advantageous when the objective is of fixed focal length type. Indeed, the fixed position of the detector relative to the objective is mitigated by the increase in the depth of field.

A first advantage of the invention arises from the capacity of the profiles S(u) of the invention to reduce, in addition to the defocusing caused by exceeding the depth of field, certain other types of defocusing which can be caused by variations in the temperature of the operating system, and/or by axial chromatic aberration or field curvature of the objective.

A second advantage of the invention is that the dimensions of the imaging system are no larger than those of an analogous system without wavefront modification. In particular, a system of the invention is smaller and less complex than a system with a temperature-compensating or achromatic objective.

In addition, the f-number of the objective is not increased, and so the sensitivity of the system remains high.

A third advantage of the invention lies in the digital processing of the captured image, which is done by the processing unit. This processing may use a deconvolution filter which is unique. This unique filter may be applied from each point in the image associated with a pixel of the detector. Indeed, with the invention, the filter can to a large extent be independent of the distance of the objects visualized by the imaging system. The processing unit can then be simpler, with a short processing time for each image. In particular, the processing of each image can be done in real time, even for rapid image changes.

Preferably, the equivalent diopter which is situated in the pupil of the objective has a longitudinal shift which corresponds to one of the profiles S(u) with a maximum deviation of less than 0.5%, or even less than 0.1% in absolute value compared to this profile. The image output by the processing unit is then even more sharp when there are wide variations in the distance of the objects in the scene.

The limit values used for the deviation between the longitudinal shift of the actual diopter and one of the profiles S(u), meaning 1%, 0.5%, and 0.1%, correspond to machine tools of increasing precision. The best precision is obtained with depth-controlled laser machining. A person skilled in the art will understand that two diopter profiles cannot be distinguished beyond the precision of the machining which is available. For this reason, the diopter which is used in the invention can have a deviation from one of the theoretical profiles which corresponds to the precision of the machine tool used to manufacture it.

In a particular embodiment of the invention, the diopter may have concentric zones. In this case, a central zone of the diopter has the longitudinal shift of the profile S(u), with a maximum deviation which is less than 1% and preferably less than 0.5%, or even less than 0.1% in absolute value relative to this profile.

Lastly, for an imaging system of the invention, the wavelength of the radiation which forms the image may belong to one of the three following ranges: [0.4 μm; 1.1 μm] which corresponds to the domains of visible light and light intensification, [1.8 μm; 2.5 μm] which corresponds to the frequency range IR1, [3 μm; 5 μm] which corresponds to the frequency range IR2, and [7 μm; 13.5 μm] which corresponds to the extended frequency range IR3.

The invention also proposes a method for increasing the depth of field of an imaging system when this system comprises:
an objective which has an optical axis and a pupil;
an image detector which is placed in an image plane of the objective and which is adapted to capture an image of a scene formed by this objective, and
a processing unit which is intended to execute a digital processing of the image captured by the detector.

This method comprises the following steps:
adapting the objective to modify a wavefront of the radiation which passes through it so that a response function of the objective becomes substantially constant over a large interval of distance variations between objects of the scene and the objective, and
adapting the processing unit to process the image captured by the detector using data of the response function.

The method is characterized in that the wavefront modification corresponds to the effect of a diopter which would be placed in at least a part of the pupil of the objective, which would be rotationally invariant about the optical axis of the objective and would have a longitudinal shift corresponding to one of the profiles S(u) described above. The correlation between the diopter and the profile S(u) corresponds to a maximum deviation from the profile which is less than 1%, and preferably less than 0.5% or even 0.1%.

In particular, when the parameter A₀ is chosen to be substantially equal to 2.5·λ/(n−1), the depth of field of the system is substantially increased by a factor of five compared to the same system without the wavefront modification corresponding to the diopter of profile S(u) situated in the pupil.

The adaptation of the objective for wavefront modification may comprise a modification of at least an initial surface of a lens, mirror, or prism of the objective. This surface modification of the lens, mirror, or prism is rotationally symmetric. It can therefore be done simply and at a low cost.

The adaptation of the objective may alternatively or additionally comprise the addition of a phase plate. Such a phase plate may also be rotationally symmetric. It is then advantageously added in the pupil of the objective.

The adaptation of the objective can be equivalent to the effect of a diopter with concentric zones, where the central zone has the longitudinal shift of the profile S(u), with a maximum deviation of less than 1% in absolute value compared to this profile, preferably less than 0.5% or even less than 0.1% in absolute value.

Lastly, the invention proposes using a method for increasing the depth of field of an imaging system as described above, for a system which operates at a radiation wavelength belonging to one of the three frequency ranges [0.4 μm; 1.1 μm], [1.8 μm; 2.5 μm], [3 μm; 5 μm], and [7 μm; 13.5 μm]. In particular, this system may comprise a pair of infrared binoculars and/or have a fixed focal distance objective.

Other features and advantages of the invention will be apparent from the following description of a non-limiting embodiment, with reference to the attached drawings, in which:

FIG. 1 is a diagram of the operation of an imaging system to which the invention can be applied;

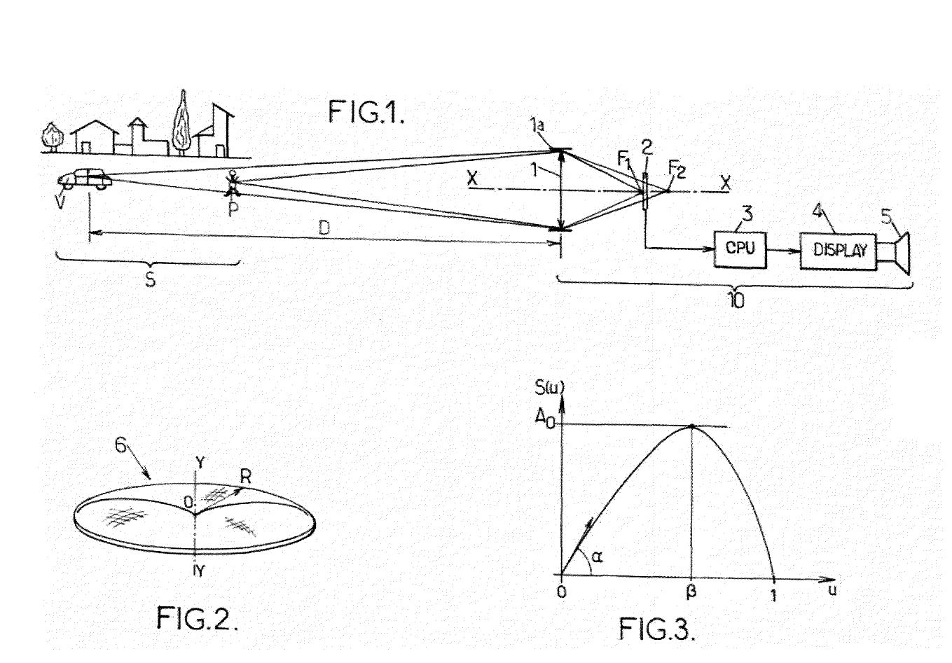

FIG. 2 represents a phase plate which may be used to implement the invention;

FIG. 3 is a chart of the profile of the phase plate of FIG. 2;

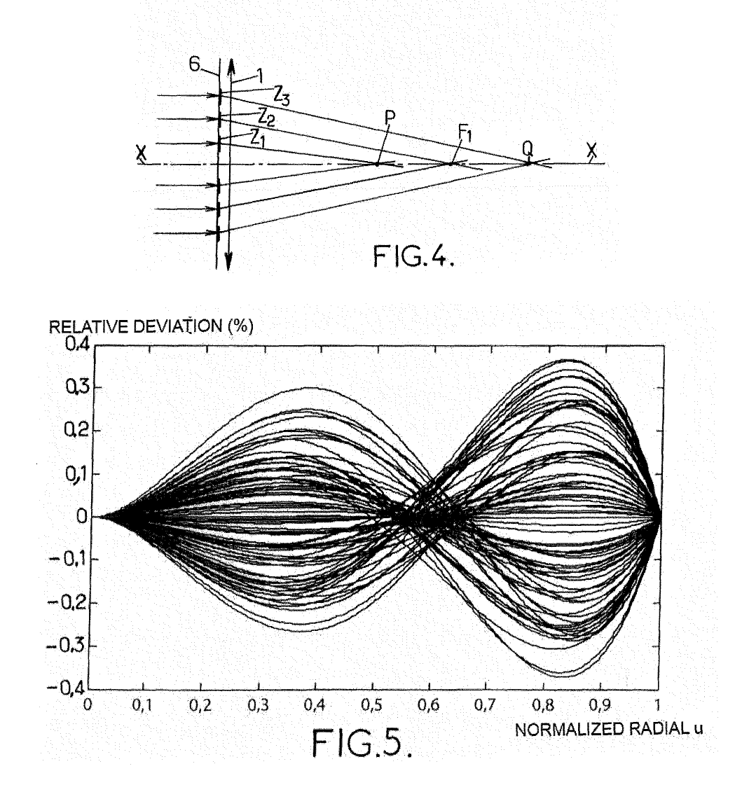

FIG. 4 illustrates an interpretation of the invention; and

FIG. 5 is a validation chart for profiles selected according to the invention.

For clarity sake, it is assumed below that the profile S(u) does not include any additional contribution corresponding to uniform curvature. Therefore S₀(u)=0 in the following description, unless stated otherwise.

In accordance with FIG. 1, an imaging system 10 to which the invention is applied comprises an objective 1, a detector 2, a processing unit 3, and a display unit 4. The objective 1 is represented in a simplified manner by a single converging lens, but it is understood that it may have a more complex structure, in particular based on multiple lenses, mirrors, and/or prisms. The detector 2, comprised of a matrix of photosensitive elements, or pixels, is superimposed on an image formation plane of the objective 1. It is perpendicular to the optical axis X-X of the objective. When the system 10 is designed for viewing objects which are at a distance from the objective 1, the detector 2 is substantially situated at the focal point of the objective 1, denoted F₁. The detector 2 is electrically connected to the processing unit, denoted CPU, so that the electrical signals produced by the pixels of the detector 2 can be digitally processed. Lastly, the processing unit 3 is itself connected to the display unit 4, denoted “DISPLAY”, which allows viewing the images captured by the detector 2 and processed by the unit 3. The display unit 4 may be, for example, a liquid crystal display.

The system 10 may be, for example, a pair of infrared binoculars. In this case, it can additionally comprise eyepieces 5 placed in front of the display unit 4.

Actually, the position of the elements of an image formed by the objective 1 along the axis X-X varies as a function of the distance D of each object in a scene located in front of the objective 1. For example, in FIG. 1, the scene S comprises a vehicle V and a person P, the latter being closer than the vehicle V to the objective 1. If the objective is calibrated so that the image of the vehicle V is formed on the sensitive surface of the detector 2, at the point F₁, then the image of the person P is formed behind the sensitive surface of the detector, at the point F₂. The images of the vehicle V and the person P are then respectively sharp and blurred.

The objective 1 has at least one pupil, which may be an entrance pupil. In a known manner, the pupil is a diaphragm which limits the aperture of the objective. In other words, the pupil transversely limits a beam of light which originates from a point in the scene S and which enters into the system 10. It therefore limits the brightness of the image which is formed by the objective 1. As an illustration, in FIG. 1, the pupil 1a of the objective 1 is constituted by the lens holder.

The ratio of the focal length of the objective 1 and the diameter of the entrance pupil 1a is commonly known as the f-number N. The sensitivity of the imaging system at low light intensities increases as the f-number N decreases.

The depth of field is the size of the interval of variations in the distance D of an object being viewed, for which the object image delivered by the imaging system 10 is sharp. For an imaging system without wavefront modification, it is determined by the dimension of the Airy disk which corresponds to the image of a point, and/or by the size of the pixels of the detector 2. In the first case, the depth of field expressed as the interval along the X-X axis within which the detector can be placed is equal to +/−2·A·N², where λ is the radiation wavelength and N is the f-number N of the objective.

In the particular embodiment of the invention which is described, the depth of field of the imaging system 10 is increased when a phase plate 6 is added to the objective 1 (FIG. 2). This is rotationally symmetric around an axis Y-Y. The axis Y-Y is therefore perpendicular to the plate 6, and intersects it at a central point denoted O. The plate 6 has a circular peripheral edge, with a radius which is denoted R. It also has a thickness which varies as a function of the radial distance relative to the axis Y-Y. This radial distance is denoted r, and u designates the ratio r/R. In other words, u is the normalized radial distance relative to the radius R of the plate 6. It is assumed that the plate 6 has a flat side, for example its lower side in FIG. 2, and a non-flat upper side. The variation in the thickness of the plate 6 between the center O and a point situated at the normalized radial distance u, is S(u). In other words, S(u) is the profile of the diopter which constitutes the upper side of the plate 6.

The plate 6 is constituted of a material transparent to the radiation which forms the image of the scene S on the detector 2. In the following description, a wavelength of this radiation is denoted as λ, and the refractive index of the material of the plate 6 for this wavelength is denoted as n.

The plate 6 is placed in the pupil 1a of the objective 1, meaning against the single lens when the objective 1 has the simplified configuration in FIG. 1. It is positioned so that the axis Y-Y of the plate 6 is superimposed on the optical axis X-X of the objective 1. In order not to reduce the f-number N of the imaging system 10, the radius R is at least equal to the radius of the pupil 1a.

According to the invention, such an arrangement of the plate 6, which is rotationally symmetric, increases the depth of field of the imaging system 10 when the profile S(u) corresponds to one of the theoretical profiles characterized by the formula (I). The multiplicative factor of the increase in the depth of field of the system 10 may be greater than three, or even greater than or equal to five, depending on the amplitude of the profile S(u) and the deviation between the actual profile of the plate 6 and the theoretical profile.

FIG. 3 is a diagram which shows the variations in one of the theoretical profiles S(u) of the formula (I) when the constant curvature term S₀(u) is zero. The x-axis shows the normalized radial distance u, and the y-axis shows the variations in S(u), meaning the theoretical variations in the thickness of the plate 6. u is without units and varies between 0 and 1.

As shown in this diagram, the selection parameters for the theoretical profiles S(u) of the formula (I) have the following significance:
α is the slope of the profile S(u) at the center O of the plate 6; meaning where u is equal to 0;
β is the value of the normalized radial distance u at which the profile reaches a maximum value, when no supplemental curvature is superimposed on the profile S(u);
A₀ is the maximum value of the profile S(u) when u is equal top; and
S₀(u) is a uniform curvature term, whose variations are superimposed on the profile S(u) of FIG. 3.

The inventors have determined that the parameter α should be between 1.0 and 6.0, the parameter β between the values 0.42 and 0.74, and the absolute value of the parameter A₀ between [1.5·λ/(n−1); 7.5·λA/(n−1)] to obtain an increase in the depth of field of the imaging system 10. In particular, when A₀ is equal to 2.5·λ/(n−1), adding the plate 6 to the system 10 increases the depth of field by a factor of 5 in comparison to the value for the system 10 without the phase plate 6.

In an interpretation of the inventors, the profiles S(u) defined by the formula (I) have the remarkable property that the illumination along the axis X-X which is produced, through the objective 1 equipped with the plate 6, by a pinpoint light source located on this axis far in front of the objective 1 is constant on both sides of the focal point F₁ of the objective 1. More specifically, these profiles S(u), associated with the intervals indicated for α, β, and A₀, ensure that this illumination is constant in a longitudinal displacement along the axis X-X of a length of less than 10·λ·N² on each side of the focal point F₁. In comparison, the depth of field of the system 10 without the plate 6, converted into the image space, corresponds to displacements on each side of the focal point F₁ along the axis X-X which are less than 10·λ·N².

FIG. 4 illustrates the transformation, by the objective 1 equipped with the plate 6, of a plane wave produced by a pinpoint light source (not represented) located far in front of the objective 1. The illumination at any point on the axis X-X which is situated between the extreme points P and Q, originates from a ring of the plate 6, centered at the axis X-X, which has a radial thickness adapted so that this illumination is the same as that produced at a nearby point of the axis X-X by an adjacent ring of the plate 6. To facilitate comprehension, Z₁, Z₂, and Z₃ denote three concentric rings of the plate 6 which respectively produce illumination concentrated at points P, F₁ and Q. Fᵢ is the focal point of the objective 1, and P and Q are situated to the front and rear of F₁, each at a distance of 10·λ·N₂.

Actuality, the zones Z₁, Z₂ and Z₃ must be imagined as infinitesimal. The varying thickness of the plate 6, as a function of the radial distance r, locally produces a diopter at an angle to the surface of the plate. This diopter directs the rays which pass through the plate at the distance r from the axis X-X towards a point on this axis which is located between the extreme points P and Q. In this manner, the plate 6 makes an adjustment to the point of convergence of the rays which pass through it, as a function of the distance of the points where these rays hit the plate. This adjustment produces an illumination between the points P and Q which is substantially constant when the plate 6 has one of the profiles S(u) of the formula (I).

In the formula (I), the term A₀·u·(u−1)·(A·u²+B·u+C) of the profile S(u) corresponds to the variation in thickness of the plate 6 which, in the invention, renders constant the illumination produced by a pinpoint light source on the optical axis X-X between the points P and Q. The profile S(u) may additionally comprise the uniform curvature term S₀(u) which is indicated in the formula (I). The inclusion of a uniform general curvature of the plate 6 has the consequence of modifying, relative to the parameter 13, the value of u at which the profile S(u) is maximal. It reveals a supplemental lens effect created by the plate 6, which is added to that of the objective 1 without a plate 6.

The inventors have additionally noted that, when the profile of the plate 6 corresponds to the formula (I), the impulse response function of the objective 1 equipped with the plate is substantially constant, no matter what the position of a light source in the scene S. In the frame of the invention, the impulse response function, also known as PSF or Point Spread Function, is used to refer to the distribution, in the plane of the sensitive surface of the detector 2, of light produced by a pinpoint light source P which belongs to the scene S and which is situated at a great distance from the objective 1. In other words, any two points of the scene S, which may be situated at different positions along the axis X-X and/or transversely offset in different manners relative to this axis, within the field of view of the system 10, produce similar illumination on the detector 2. Similar illumination is understood to mean light distributions which differ on the detector 2 only by an intensity factor, although centered at different points. Thus, in the invention, the illumination invariance which is created on between the points P and Q of the axis X-X by a pinpoint light source, remarkably results in invariance in the impulse response function no matter what the position of the pinpoint light source in the field of view. The processing unit 3 can then apply the same demodulation function, or filter, at all points of the image captured by the detector 2, to compensate for the impulse response of the objective 1 equipped with the plate 6. An improved resolution of the image displayed by the unit 4 is thus obtained in comparison to the same image without digital processing, although this processing is simple and constant.

A validation of the invention was performed by the inventors in the following manner, using digital simulations. Initial profiles with rotational symmetry were generated for the plate 6, which corresponded to fourth-degree polynomials relative to u. The coefficients of each of these polynomials were then optimized, so that the illumination produced on the axis X-X between the points P and Q was constant for a pinpoint light source belonging to the scene S. They then determined, for each of these optimized profiles, the slope at the center O of the plate 6, as well as the radial distance and the amplitude of the maximum thickness of the plate. These values were then identified with the parameters α, β, and A₀ of the formula (I). Thus a theoretical profile of the formula (I) was associated with each optimized profile. The inventors then observed that each optimized profile was very close to the corresponding theoretical profile. FIG. 5 illustrates this validation, showing the relative deviation between the optimized profile and the theoretical profile for a large number of optimized profiles. In this figure, the x axis shows the values of the normalized radial distance u, and the y axis shows, for each optimized profile Sₒₚₜ, the value of the quotient [Sₒₚₜ(u)−S_{α,β,Ao}(u)/S_{α,β,Ao}(u)]. This relative deviation is less than 0.4% for any optimized profile obtained.

It is understood that many modifications may be introduced relative to the embodiment of the invention just described. One can cite the following examples:
the wavefront modification plate may be placed outside the pupil of the objective, subject to its profile being adapted to obtain an identical modification of the wavefront in the pupil. The inventors indicate that the plate placed outside the pupil still possesses rotational symmetry;
the wavefront modification of the invention may be achieved by means of an initial optical component of the objective 1, without the addition of a phase plate. In particular, this component may be a lens, mirror, or prism. In this case, the profile of a side of the component is modified in a manner which is optically equivalent to the profile S(u) situated in the pupil of the objective;
when the profile modification is applied to a side of an initial optical component of the objective 1, this side may initially be aspherical. The modification then constitutes a supplemental component of the profile of this side, which corresponds to the wavefront modification of the invention. Only this supplemental component of the profile then possesses rotational symmetry;
the profile S(u) may be applied to only a part of a phase plate or of an optical component of the objective 1, so that it only has an effect on part of the beam of light entering the objective. It is also possible for the profile S(u) to be applied to only a ring of an optical component, with said ring being centered relative to the optical axis of the objective. Preferably, such a ring is central, meaning it extends continuously between the optical axis X-X and a maximum radius which is less than that of the radiation beam at the optical component; and
lastly, the profile S(u) of the plate 6 may be converted into a profile of the variations in the plate's refractive index n. Indeed, it is known that a variation in the thickness of a refractive material is equivalent to a variation in the index, according to the formula: Δn(u)=(n−1)·S(u)/e, where n and e are respectively the mean index and the nominal thickness of the plate 6, and Δn(u) is the deviation from the nominal value n of the refractive index of the plate for the value u of the normalized radial distance.

1. Imaging system (10) comprising,
an objective (1) having an optical axis and a pupil,
an image detector (2) placed in an image plane of the objective and adapted to capture an image of a scene formed by said objective, and
a processing unit (3) intended to execute a digital processing of the image captured by the detector,
the objective (1) being additionally adapted to modify a wavefront of a radiation passing through said objective, so that a response function of the objective is substantially constant over a large interval of variations in a distance between objects in the scene and the objective, and
the processing unit (3) being adapted so that the processing of the image captured by the detector is based on data of said response function,
the system (10) being characterized in that, the wavefront modification corresponds to an effect of a diopter situated in at least a part of the pupil of the objective, said diopter being rotationally invariant about the optical axis of the objective and having a longitudinal shift corresponding to one of the following profiles S(u), with a maximum deviation of less than 1% in absolute value relative to said profile:
S(u)=A₀u(u−1)(Au²+Bu+C)+S₀(u)
where u=r/R, r being the radial distance in the pupil and R the radius of said pupil,
$$A = \frac{2 - 3 β - {αβ ( β - 1 )}^{2}}{{{β}^{3} ( β - 1 )}^{2}} ;$$
$$B = \frac{4 β - 3 + 2 {αβ ( β - 1 )}^{2}}{{{β}^{2} ( β - 1 )}^{2}}$$
$$and$$
$$C = - α$$
α, β, and A₀ being selection parameters for the profile, which are within the following intervals:
[1.0; 6.0] for α
[0.42; 0.74] for β; and
[1.5λ(n−1); 7.5λ(n−1)] for A₀ using the absolute value,
λ being a wavelength of the radiation that forms the image and n being an optical refractive index of the diopter for said wavelength, and
S₀(u) being a contribution to the diopter profile corresponding to a constant curvature of said diopter.

2. System according to claim 1, wherein the maximum deviation between the longitudinal shift of the diopter and one of the profiles S(u) is less than 0.5% in absolute value.

3. System according to claim 1, wherein the wavelength of the radiation which forms the image belongs to one of the three ranges [0.4 μm; 1.1 μm], [1.8 μm; 2.5 μm], [3 μm; 5 μm], and [7 μm; 13.5 μm].

4. System according to claim 1, wherein the objective is of fixed focal distance type.

5. System according to claim 1, comprising a pair of infrared binoculars.

6. System according to claim 1, wherein the diopter has concentric zones, a central zone of said diopter having the longitudinal shift of the profile S(u), with a maximum deviation of less than 1% in absolute value relative to said profile.

7. System according to claim 1, wherein the wavefront modification is at least partially provided by a surface of a lens, mirror, or prism of the objective.

8. System according to claim 1, additionally comprising a phase plate (6) adapted to produce the wavefront modification.

9. System according to claim 8, wherein the phase plate (6) is placed in the pupil of the objective.

10. System according to claim 1, wherein the processing unit (3) is adapted to process the image captured by the detector (2) with a constant deconvolution filter.

11. Method for increasing the depth of field of an imaging system (10), said system comprising:
an objective (1) having an optical axis and a pupil,
an image detector (2) placed in an image plane of the objective and adapted to capture an image of a scene formed by said objective, and
a processing unit (3) intended to execute the digital processing of the image captured by the detector,
said method comprising the following steps:
adapting the objective (1) to modify a wavefront of a radiation which passes through said objective so that a response function of the objective becomes substantially constant over a large interval of variations in a distance between objects of the scene and the objective, and
adapting the processing unit (3) to process the image captured by the detector using data of said response function,
said method being characterized in that the wavefront modification corresponds to an effect of a diopter situated in at least a part of the pupil of the objective, said diopter being rotationally invariant about the optical axis of the objective and having a longitudinal shift corresponding to one of the following profiles S(u), with a maximum deviation of less than 1% in absolute value relative to said profile:
S(u)=A₀u(u−1)(Au²+Bu+C)+S₀(u)
where u=r/R, r being the radial distance in the entrance pupil and R the radius of said pupil,
$$A = \frac{2 - 3 β - {αβ ( β - 1 )}^{2}}{{{β}^{3} ( β - 1 )}^{2}} ;$$
$$B = \frac{4 β - 3 + 2 {α ( β - 1 )}^{2}}{{{β}^{2} ( β - 1 )}^{2}}$$
$$and$$
$$c = - α$$
α, β, and A₀ being selection parameters for the profile, which are within the following intervals:
[1.0; 6.0] for α
[0.42; 0.74] for β; and
[1.5λ(n−1); 7.5λ(n−1)] for A₀ using the absolute value,
λ being the wavelength of the radiation that forms the image and n being an optical refractive index of the diopter for said wavelength, and
S₀(u) being a contribution to the diopter profile corresponding to a constant curvature of said diopter.

12. Method according to claim 11, wherein the maximum deviation between the longitudinal shift of the diopter and one of the profiles S(u) is less than 0.5%, in absolute value.

13. Method according to claim 11, wherein the parameter A₀ is substantially equal to 2.5λ(n−1), so that a depth of field of the system is substantially increased by a factor of five relative to the same system without the wavefront modification corresponding to the diopter with profile S(u) situated in the pupil.

14. Method according to claim 11, wherein the diopter has concentric zones, a central zone of said diopter having the longitudinal shift of the profile S(u), with a maximum deviation of less than 1% in absolute value relative to said profile.

15. Method according to claim 11, wherein the objective (1) is adapted to modify the wavefront by modifying at least an initial surface of a lens, mirror, or prism of said objective.

16. Method according to claim 11, wherein the objective (1) is adapted to modify the wavefront by adding a phase plate (6) to said objective.

17. Method according to claim 16, wherein the added phase plate (6) is placed in the pupil of the objective.

18. Utilization of a method according to claim 11, for an imaging system operating at a radiation wavelength belonging to one of the three frequency ranges [0.4 μm; 1.1 μm], [1.8 μm; 2.5 μm], [3 μm; 5 μm], and [7 μm; 13.5 μm].

19. Utilization according to claim 18, when the imaging system comprises a pair of infrared binoculars.

20. Utilization according to claim 18, when the objective of the imaging system is of fixed focal distance type.
